(19) United States
(12) Patent Application Publication
(10) Pub. No.: US 2007/0205979 A1
(43) Pub. Date: Sep. 6, 2007

(54) Electro-optical modulating display devices comprising and array of microcells and a method for making such devices

(76) Inventors: Donald O. Bigelow, Honeoye Falls, NY (US); Ronald M. Wexler, Rochester, NY (US)

Correspondence Address: Paul A. Leipold;Patent Legal Staff, Eastman Kodak Company, 343 State Street, Rochester, NY, 14650-2201, US

(21) Appl. No.: 11/366,118

(22) Filed: Mar. 2, 2006

(51) Int. Cl. G09G 3/34

(52) U.S. Cl. 345/107

(57) ABSTRACT

The present invention relates generally to the field of electro-optical modulating displays, for example, electrophoretic displays and, specifically, to a method of manufacturing such displays. In particular, the invention relates to electro-optical modulating display structures and methods of sealing fluid-based imaging material in microcells.

### FIELD OF THE INVENTION

The present invention relates generally to the field of electro-optical modulating displays, for example, electrophoretic displays and, specifically, to a method of manufacturing such displays. In particular, the invention relates to methods of sealing fluid-based imaging materials in microcells associated with such electro-optical modulating displays.

### BACKGROUND OF THE INVENTION

As one type of electro-optical modulating display, the electrophoretic display offers an electronic alternative to conventional printed-paper media for many applications. The electrophoresis phenomenon is based on charged particles suspended in a liquid fluid, for example charged pigment particles in an organic solvent. Unlike sheet materials containing magnetic memory areas that can be written electronically, an electrophoretic display advantageously provides a visible record for the viewer.

Electrophoretic media systems exist that maintain electronically changeable data without power, such as devices available from E-ink Corporation, Cambridge, Mass., or GYRICON systems from Xerox Corporation, Stamford, Conn.

As initially proposed in the late 1960's, the electrophoretic display typically comprises two plates with electrodes placed opposing each other, separated by spacers. One of the electrodes, for placement nearer to the viewer, is usually transparent. In one prior-art embodiment, a fluid suspension composed of a colored solvent and charged pigment particles is enclosed between the two plates. When a voltage difference is imposed between the two electrodes, the pigment particles migrate to one side, such that either the color of the pigment or the color of the solvent is predominant, depending on the polarity of the voltage difference.

Since the inception of this technology, there has been considerable research directed to its implementation and optimization. For example, in order to prevent undesired movement of the particles, such as sedimentation or lateral migration, partitions between the two electrodes were proposed for dividing the space into smaller cells. However, in the case of partition-type electrophoretic displays, difficulties were encountered in the formation of the partitions, in the process of enclosing the fluid suspension, and in the case of colored displays, in segregating different colored fluid suspensions from each other in partition-type electrophoretic displays.

Partitioning electrophoretic displays into smaller cells has been accomplished by a photolithographic process. This is a batchwise process requiring solvent development step. In order to provide high throughput, especially a continuous process, roll-to-roll micro-embossing processing has been proposed as an alternate fabrication method for microcell formation in an electrophoretic display. For example, U.S. Pat. No. 6,831,770 B2 entitled “Electrophoretic Display and Novel Process for its Manufacture” to Liang et al. discloses an electrophoretic display comprising microcells, termed microcups, that are filled with charged particles dispersed in a solvent, wherein each cell is individually sealed with its own polymeric sealing layer or cap.

Liang et al. obtains a polymeric sealing layer in each microcup by adding, and thoroughly blending, a sealing composition to each individual microcup along with the electrophoretic fluid containing charged pigment particles dispersed in a colored dielectric solvent. For example, an in-line mixer or other blending apparatus can be used to mix the two materials. Then, the mixture can be immediately coated onto a sheet having microcups, using a precision coating mechanism such as Myrad bar, gravure, doctor blade, slot coating, or slit coating. Notably, the sealing composition is immiscible or otherwise incompatible with the solvent and has a lower specific gravity than the solvent and pigment particles. The sealing composition in each microcup, therefore, forms a supernatant layer on top of the charged pigment dispersion, which sealing composition is hardened using radiation, heat, moisture, or some other means in order to form a seal. In this way, each microcup becomes a separately sealed container with an electrophoretic fluid mixture. The process described by Liang et al. can be, for example, a continuous roll-to-roll process, as shown in FIG. 6 of the afore-mentioned U.S. Pat. No. 6,831,770 B2.

Thus the method of the Liang et al. involves individually sealing the microcup cells, that is, the sealing layer for each microcup can be formed as an individual seal that is discontinuous with the sealing layer for each of the surrounding microcups in an array of microcups, and a common sealing layer does not seal a plurality of microcups. Once the microcups are individually sealed, only then is a lamination sheet applied over the microcups, wherein the lamination sheet is a second conductor film pre-coated with an adhesive layer.

In an alternate embodiment disclosed by Liang et al. in U.S. Pat. No. 6,831,770 B2, a sealing layer can be formed by overcoating the microcups, once filled with electrophoretic fluid, with a thin layer of a sealing composition. Liang et al. state that the sealing layer may extend over the top surface of the cell side walls (FIG. 8), thereby forming a stopper-shaped sealing layer having a thickness ranging from about 0.1μ to about 50 μm, in which the cell is only partially filled with the electrophoretic fluid.

Among the problems with the type of sealing arrangement in Liang et al. are difficulties in preventing or minimizing the degree of intermixing between the sealing composition and the pigment dispersion. Also, it is difficult to adjust the thickness of the seal, which needs to be much less than that of the electrophoretic fluid in order to provide the necessary optical density. Consequently, the specific gravity and viscosity of the materials must be carefully controlled, which limits the materials that can be used. Volatile solvents and fluorinated compounds may be used to adjust properties such as the viscosity and the thickness of the coatings. However, this adds complexity and further steps to the fabrication process.

U.S. Pat. No. 6,940,634 entitled “Electrophoretic Display Device” to Ukigaya describes an improvement on the prior-art manufacture of an electrophoretic display device in which a substrate and the top surfaces of the microcell walls in a microcell sheet are adhered together through an adhesive layer. Ukigaya states that the prior-art production steps and apparatus for forming the adhesive layer are complicated and can cause yield reductions or increased production costs. As a solution, Ukigaya proposes using an electrode having adhesive properties. An adhesive electro-conductive resin is applied between the partition wall of a microcell and a protective substrate, in order both to eliminate the prior-art adhesive layer and to provide electrical connections to each cell. This type of approach may prove useful for some types of electrophoretic cell design, but would offer no advantage for an in-plane electrode design, in which all electrodes lie in the same plane within the electrophoretic cell. Also, the requirement for electrical conductivity of the adhesive significantly narrows the choices of adhesive material available, and steps taken to provide or enhance resin conductivity using metallic powders or other particulates could cause disadvantageous optical effects in the display.

In yet another prior-art approach, disclosed in US Patent Application Publication No. 2005/0122565 A1 entitled “Electrophoretic Displays and Materials for Use Therein” to Doshi et al., a display is formed by laminating a first substrate having a layer of encapsulated electrophoretic medium (capsules in a binder) to a second substrate, a backplane, using a lamination adhesive. Doshi et al. state that such a process allows for mass production of displays by roll lamination. However, in this process, before the lamination step, the electrophoretic medium is first dried to form a coherent layer of material. Doshi et al. also state that similar manufacturing techniques can be used with other types of electro-optical modulating displays. Doshi et al. also disclose the use of vacuum lamination; however, this would be inappropriate with liquid or other materials that are not already bonded to an underlying substrate in some way.

US Patent Publication No. 2005/0133154 entitled “Method of Sealing an Array of Cell Microstructures Using Microencapsulated Adhesive” to Daniel et al. states that one known method of sealing microcells involves providing a wall microstructure on a first flexible substrate, coating a second flexible substrate with a substantially continuous layer of adhesive or sealant, and positioning the second flexible substrate on the end portion of the wall microstructure (apparently the top surface of the side walls) to effectively seal the microcells.

Daniel et al., however, point out disadvantages of applying a continuous layer of adhesive onto a substrate for bonding to cell walls for sealing the electrophoretic microcells. Notably, excess liquid adhesive that is not used in forming the bond with the wall microstructure of the microcells tends to migrate into or otherwise intermix with the contents of the cells. This unwanted mixing could undesirably affect properties of the electrophoretic substance contained within the cells. To overcome this problem, Daniel et al. disclose a method of sealing an array of cell microstructures using a microencapsulated adhesive. In one particular embodiment (as shown in FIG. 3 of the Daniel et al. disclosure), a second substrate having a plurality of adhesive microcapsules supported on a first side of the second substrate is displaced against portions of the microcell microstructure on a first substrate. As the second substrate approaches the wall microstructure, a portion of the microcapsules are compressively captured between opposing contact points and rupture, thereby locally dispensing the adhesive contained therein. Consequently, each individual microcell is substantially sealed by a locally released adhesive substance, and any remaining adhesive microcapsules simply remain, sealed and trapped within the fully enclosed and sealed cells. With this type of approach, care must be taken to distribute the microcapsules suitably for obtaining sufficient levels of localized adhesion. Also, the microcapsules themselves must be fabricated from materials and in shapes that are compatible with the light-handling requirements of the electrophoretic device. Microcell walls themselves must allow sufficient compression force to break open the compressively captured portion of the microcapsules for sealing. Thus, while this type of approach may prove useful for some microcell-sealing applications, there are drawbacks and limitations to such a solution for the broad range of electrophoretic and other electro-optical modulating display applications

U.S. Pat. No. 6,525,865 to Katase discloses ejecting a sealing composition over pores or openings in individual cells and then applying a substrate over the sealed openings.

In view of the above, conventional approaches for sealing an array of microcells in an electro-optical modulating display have not provided solutions that are sufficiently adaptable and robust for large-scale production. Among the problems that have not been adequately addressed are difficulties due to the composition of the electrophoretic fluid itself. Many of the liquids and solvents used can even prove inimical to conventional surface adhesion materials and techniques or, at best, allow only marginal performance. Self-capping approaches such as those taught by Liang et al. and elsewhere place constraints on both the electrophoretic composition and on the sealing materials themselves. The adhesive electrode taught in the Ukigaya disclosure allows only a narrow range of materials and is not appropriate for designs using an in-plane electrode layout. The method of Doshi et al., involving lamination, may be suitable for electrophoretic composite materials that are not fluid in nature, but do not satisfy the more demanding requirements posed by microcells containing a fluid electrophoretic medium. Finally, adhesive capsules as proposed by Daniel et al. allows only a narrow range of adhesives, may pose limitations due to cost and suitability for mass manufacture, and may result in a residue of material in the microcells that can adversely effect optical performance. Still another problem with sealing an array of microcells, particularly when simultaneously laminating and sealing an array of fluid-containing microcells is to prevent or limit the entrapment of any air while sealing the microcells, since air bubbles formed in sealed microcells will result in undesirable variations in image density among the microcells.

Thus, in practice, there are a number of difficulties that pose significant difficulties and undesirable complications in manufacturing microcell-based electro-optical modulating displays, particularly for the tasks of filling and sealing microcell reservoirs. Among problems that must be addressed or resolved are the following:

(i) Each microcell reservoir must be filled to the proper depth, with the correct mixture of electro-optical imaging fluid.

(ii) In general, the electro-optical imaging fluid itself is incompatible with many adhesives, such as those that might otherwise be used to affix the material of a sealing layer with the material of microcell side walls. For example, many types of electrophoretic fluids comprise an oil-based carrier medium that inevitably is deposited on the top surfaces of the microcell side walls intended for adhesive contact.

(iii) Entrapment of gas bubbles, typically air, in each filled microcell reservoir must be avoided or limited.

(iv) The sealing layer preferably should be sufficiently flexible, allowing a suitable amount of bending of the display device without damage.

(v) The sealing material must not significantly compromise optical density.

As described above, there have been a number of prior attempts at addressing filling and sealing problems, but each proposed solution has its drawbacks.

### PROBLEM TO BE SOLVED BY THE INVENTION

Thus, there is a need for improved methods of filling and sealing fluid-containing microcells in electro-optical modulating displays, which methods are adaptable to high-volume manufacturing environments that require high yields, greatly reduce the constraints on the applicable materials that can be used in carrying out the method, and result in few or no adverse affects on image quality. There is also a need for structures for electro-optical modulating displays that are simpler and more economical to manufacture without sacrificing imaging performance or durability or greatly reducing the constraints on the particular materials and process steps selected for sealing.

### SUMMARY OF THE INVENTION

The present invention is directed to overcoming one or more of the problems set forth above. Briefly summarized, according to one aspect of the present invention, a method for producing an electro-optical modulating display comprises:

(a) providing a partitioned sheet comprising an array of microcell reservoirs, each microcell reservoir being no longer than 1000 μm along any dimension thereof, each microcell reservoir formed by side walls extending vertically from a lower substrate, that divide or partition the microcell reservoirs from each other, and containing an electro-optical imaging fluid, for example, comprising charged particles dispersed in a carrier fluid;

(b) providing a cover sheet, wherein at least one of the partitioned sheet and the cover sheet comprises patterned electrodes, which may be transparent, and wherein at least one of the cover sheet and the partitioned sheet has a plurality of filling holes and optionally at least one of the partitioned sheet and the cover sheet comprises a patterned or unpatterned adhesive layer;

(c) bonding the cover sheet to the partitioned sheet to form a ventable microcell sheet assembly such that the cover sheet is adherently connected to at least the tops of the side walls of the microcell array, thereby covering each microcell reservoir in the array to form an array of microcells each forming an internal enclosure or chamber except for one or more filling holes associated with each microcell in the array, thereby allowing the microcells be filled with an electro-optical imaging fluid;

(d) subjecting the array of microcells in the ventable microcell sheet assembly to vacuum in order to create a vacuum in each microcell in the array of microcells, thereby evacuating the microcells in the array;

(e) temporarily sealing each of the microcells in the array by forming a temporary seal over the one or more filling holes in each microcell while maintaining vacuum inside the microcells, thereby obtaining a temporarily sealed evacuated microcell sheet assembly;

(f) removing the temporary seal and filling each of the microcells in the array by drawing an electro-optical imaging fluid into the internal enclosures of the microcells, for example, when the electro-optical fluid is under pressure relative to the vacuum in the microcell, such as when the microcell is immersed in electro-optical imaging fluid under atmospheric pressure;

(g) permanently sealing the filling holes to completely enclose the electro-optical imaging fluid in the microcells of the array, for example, with a unitary sealing sheet placed over the filling holes.

Electro-optical modulating displays include electrophoretic, electrowetting, electrochromic, or any other displays utilizing microcells that need to be filled with a fluid-containing composition, whether liquid, gaseous, particulate, or particulates in a gas or liquid.

Another aspect of the present invention is directed to an electro-optical modulating display comprising an array of microcells each sealingly filled with electro-optical imaging fluid, the display comprising:

(a) a first sheet comprising an array of microcell reservoirs, each microcell reservoir being no longer than 1000 μm along any dimension thereof, each microcell reservoir formed by side walls extending vertically from a lower substrate and containing electro-optical imaging fluid;

(b) a second sheet laminated to the first sheet, the second sheet covering each of the filled microcell reservoirs in the array, wherein the second sheet is bonded to the tops of the side walls of each microcell reservoir in the array, wherein either the first sheet and/or the second sheet comprises a sheet comprising a plurality of sealed filling holes such that one or more of the plurality of sealed filling holes is associated with each microcell in the array, and wherein the sealed filling holes in each of the microcells in the array have been commonly sealed by a unitary layer of material;

(c) an electrical driver for providing control of electrical switching of the optical state of the electro-optical imaging fluid in each microcell in the array.

The present invention is advantageous in allowing sealing under ideal conditions, without interference from electro-optical imaging fluids that can interfere with bonding. For that reason, wider latitude in choice of adhesive materials and electro-optical imaging fluids is provided, since their impact on sealing can be discounted in the present process. This process also allows roll-to-roll processing for better manufacturing productivity.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 shows a partitioned sheet of material in one embodiment of the invention that is used for making a microcell sheet assembly;

FIG. 2A shows a first embodiment of the present process in which two sheet materials are joined together to form a ventable microcell sheet assembly having filing holes in the top sheet material and adhesive material on the top surface of the microcell walls of the bottom sheet material;

FIG. 2B shows a second embodiment of the present process in which two sheet materials are joined together to form a ventable microcell sheet assembly having filing holes in the top sheet material and adhesive material on the bottom surface of the top sheet material;

FIG. 3A shows a third embodiment of the present process in which two sheet materials are joined together to form a ventable microcell sheet assembly having filing holes in the bottom sheet material and adhesive material on the top surface of the microcell walls of the bottom sheet material;

FIG. 3B shows a fourth embodiment of the present process in which two sheet materials are joined together to form a ventable microcell sheet assembly having filing holes in the bottom sheet material and adhesive material on the bottom surface of the top sheet material;

FIG. 4 shows a cross-section of microcell wall showing hole diameter relationship with lower cell wall width, so that an individual filing hole cannot access two separate adjacent microcell reservoirs simultaneously;

FIG. 5A shows a plan view of one embodiment of a design for a pattern of filling-holes in a substrate in which the holes are random;

FIG. 5B shows a plan view of second embodiment of a design for a pattern of filling-holes in a substrate in which the holes are non-random;

FIG. 6 shows a first embodiment of the process steps of evacuating the microcell reservoirs while the structure is in a vacuum chamber and, subsequently, temporary sealing of the hole pattern with an additional substrate with adhesive on one side thereof to form a temporarily sealed evacuated microcell sheet assembly;

FIG. 7 shows a second embodiment of the process steps involving evacuation of the microcell reservoirs while the structure is in a vacuum chamber and, subsequently, the temporary sealing of the hole pattern with a temporary sealing layer on the bottom of the bottom sheet material, wherein the integrated assembly is sealed by forming a roll within the vacuum chamber to form a temporarily sealed evacuated microcell sheet assembly;

FIG. 8 shows one embodiment of filing the evacuated microcell sheet assembly using an imaging fluid tank, cleaning the hole-containing surface, permanently sealing it with a third adhesively bonded sheet material, and rolling the completed assembly into a roll;

FIG. 9 shows a second embodiment of filing the evacuated microcell sheet assembly using an imaging fluid tank, cleaning the hole-containing surface, and permanently sealing it with a third adhesively bonded sheet material, except using a feed roll such as shown in FIG. 7 that is also immersed in an imaging fluid tank.

To facilitate understanding, identical reference numerals have been used, where possible, to designate identical elements that are common to the figures.

### DETAILED DESCRIPTION OF THE INVENTION

As indicated above, the present invention is directed to a method of manufacturing an array of microcells. In one embodiment, the present invention relates to a method of making a display device comprising a substrate or support, a patterned conductor, and an array of microcells containing electro-optical imaging fluid. The electro-optical imaging fluid used in the present invention is a light modulating fluid, and can be reflective or transmissive. Such light modulating fluid materials can be, for example, electrochemical, electrophoretic, or electrochromic, or may comprise particles such as GYRICON particles or liquid crystals. The imaging fluid may contain particles that are liquid or solid, and a carrier fluid that may be liquid or gaseous. In one embodiment the light-modulating fluid comprises an electrophoretic material.

For the imaging device made by the present invention, preferably a flexible support substrate bears an electrically modulated imaging layer over at least one surface. As used herein, the terms “over,” “above,” “on,” “under,” and the like, with respect to layers in the display element, refer to the order of the layers over the support, but do not necessarily indicate that the layers are immediately adjacent or that there are no intermediate layers. The term “front,” “upper,” and the like refer to the side of the display element closer to the side being viewed during use.

For the description of the present invention that follows, drawings are provided to illustrate key concepts, processes, and relationships. It must be noted that structures in these drawings are not drawn with attention to scale, but rather to show key structural components and functional relationships more clearly.

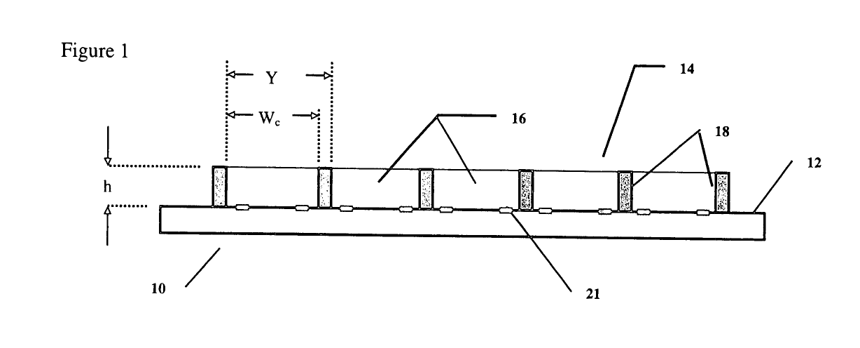

FIG. 1 shows a partitioned sheet 10 comprising a single row of microcell reservoirs 16, unfilled, in cross-section. A support 12 is provided, typically a flexible substrate, such as plastic, or glass. An array 14 of microcell reservoirs 16 is formed onto support 12 by forming side walls 18 on the surface of support 12. Side walls 18 may be formed in any of a number of ways, including microembossing, extrusion roll molding, inkjet deposition, or photoresist methods, for example. Walls 18 can be formed from an epoxy or thermoset or similar material, for example. Microcell reservoirs 16 have a height h and cell width w_{c} as shown in FIG. 1 and may have a length 1 normal to the page (not visible in the view of FIG. 1A). A distance y is the repeating microcell pitch, the significance of which will be described below. Preferably, microcell reservoir 16 is no longer than 1000 μm, preferably 100 to 1000, more preferably 200 to 600 μm, along any dimension thereof. Microcell reservoirs 16 can be symmetrical or non-symmetrical, in various shapes, e.g. circular, rectangular, hexagonal, etc. Preferably, the microcell reservoirs 16 are rectangular in cross-section. From a plan view, microcell width w_{c} and the dimension orthogonal to width w_{c} in the same plane should have a dimensional ratio from 1:1 to 1:5. Subsequent description gives more detailed information on side walls 18 fabrication.

The microcell reservoirs need to be filled with an electro-optical imaging fluid. The imaging optical state of this material is controlled by signals provided at one or more electrodes 21. In one embodiment, a dual set of electrodes 21 can be on the same side of microcell reservoir 16, referred to as an in-plane arrangement. Alternately, electrodes 21 can be placed at different positions, in other embodiments or variations of display devices, as is familiar to those skilled in the electro-optical imaging arts. Electrodes can be in-plane, out-of plan, or dual electrodes. The electrodes 21 can be formed onto support sheet 12 before or after walls 18 are formed, using techniques such as microlithography or other deposition methods. Where necessary, electrodes 21 can be transparent, formed from materials such as ITO (Indium-Tin-Oxide) for example. Optionally, one or more electrodes 21 can be formed on a cover sheet, as described subsequently. There may be more than two electrodes associated with each cell.

A display, in the simplest form, is a device comprising row and column electrodes in which an electric field or electron transfer causes a material to light shift or modulate. A pixeled display is an array of microcells formed by row and column electrodes with independent control for varying the electrical field intensity with respect to each pixel. Preferably, each microcell in the microcell array is associated with not more than one image pixel. The electro-optical imaging fluid associated with each pixel can be shifted in response to field changes. A cross-over is two or more electrodes that intersect each other at different height planes. They are usually separated by a dielectric or otherwise insulating material. An electrically conductive material typically is, but is not limited to, a line. A bus bar is a highly conductive electrode that supplies or feeds other electrodes or electrical devices. A gate electrode is an electrode that controls the movement of materials that have an electrical charge. By making the gate electrode the same charge as the particles or droplets contained in the electro-optical imaging fluid, the material will be electrical repelled from the gate, and therefore the gate can prevent the material from moving to proximate areas of the pixel. A collector is an electrode that is used to assemble or otherwise attract and hold materials that have a charge in the electro-optical imaging fluid. The collector electrode attracts the material using an opposite charge to that the material. It usually is a small area outside of the viewing area for the pixel. As used herein the terms “dielectric” and “electrically insulating” mean the same thing. They refer to materials that generally do not substantially conduct electricity.

A helper is an electrode used to assist the movement of materials so as to spread them out in a somewhat uniform manner. Typically the electrical field lines are more intense on the edges and charged particles in the electro-optical imaging fluid will tend to concentrate on the edge closest to the particles. By applying a slightly more intense electrical field on the opposite edge, the material will tend to spread out more uniformly over a larger area.

A flag is an electrode (also called a view electrode) having an area in which material is moved for viewing. The area footprint is much larger than the other electrodes. By moving material in and out of the flag area, the color of the pixel can be changed.

As indicated above, the present invention is directed to a method for producing an electrophoretic, electrowetting, or other electro-optical modulating display, the method comprising:

(a) providing a partitioned sheet comprising an array of microcell reservoirs, each microcell reservoir being no longer than 1000 μm along any dimension thereof, each microcell reservoir formed by side walls extending vertically from a lower substrate and containing an electro-optical imaging fluid, preferably comprising charged particles dispersed in a carrier fluid;

(b) providing a cover sheet, wherein at least one of the partitioned sheet and cover sheet comprises patterned electrodes, which may be transparent, and wherein at least one of the cover sheet and partitioned sheet has a plurality of filling holes and optionally at least one of the sheets comprises an adhesive layer;

(c) laminating or otherwise binding or joining the cover sheet and partitioned sheet together to form a ventable microcell sheet assembly such that the cover sheet is adherently connected to at least the tops of the side walls of the microcell array, thereby covering each microcell reservoir in the array to form an array of microcells each forming an internal enclosure except for one or more filling holes associated with each microcell in the array, thereby allowing the microcells be filled with an electro-optical imaging fluid;

(d) subjecting the array of microcells in the ventable microcell sheet assembly to a vacuum in order to create a vacuum in each microcell in the array of microcells, thereby obtaining evacuated microcells;

(e) temporarily sealing each of the microcells in the array of microcells by forming a temporary seal over the one or more filling holes in each microcell while maintaining a vacuum inside the microcell;

(f) removing the temporary seal and filling each of the microcells in the array by drawing in an electro-optical fluid;

(g) permanently sealing the filling holes to completely enclose the electro-optical imaging fluid in the microcells.

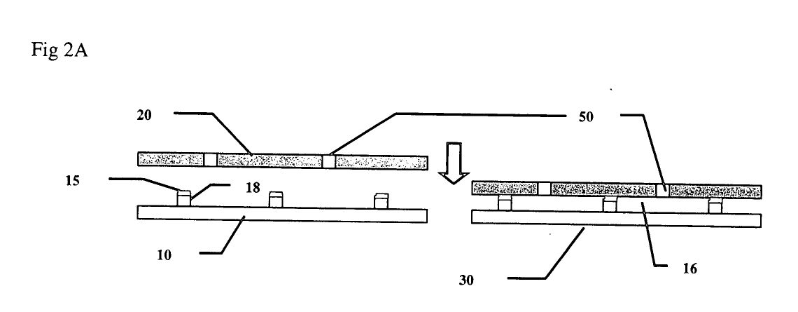

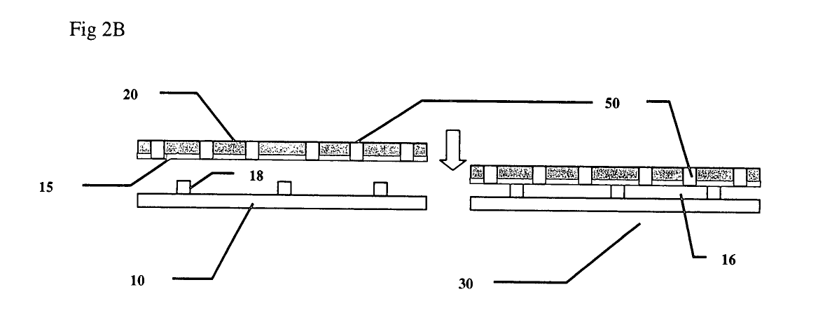

FIG. 2A shows a first embodiment of one stage of the present process in which two sheet materials, (1) a cover sheet 20 having filling holes 50, and (2) a partitioned sheet 10 are joined or bonded together to form a ventable microcell sheet assembly 30 having filing holes 50 and reservoirs 16 associated with each microcell in an array. In this embodiment, an adhesive layer 15 on the top surfaces of the microcell walls of the cover sheet 10 is used to form a bond. The filling holes 50 will be used for filling the microcells with imaging fluid, as will be explained in further detail below. Only the tops of the side walls 18 are shown covered by an adhesive layer, although optionally the adhesive can also cover a portion or all of the sides of the side walls 18. In fact, the adhesive can be applied to cover the entire top surface of the array of microcell reservoirs or the entire top surface of the partitioned sheet 10, including the side walls and bottoms of the microcells.

The sheets can be laminated together, for example, by a standard rolling lamination process in which the sheets 10 and 20 are processed through a nip formed by two rollers, at least one of which may be heated to activate an adhesive material. Rotation of the rollers moves the sheets forward into the nip and in a lamination direction, also referred to as the machine direction. Thus, the cover sheet 20 can be fed into the nip along with partitioned sheet 10. As indicated below, an adhesive layer can be applied to either the cover sheet or the partitioned sheet, or both, at some point prior to the nip. For example, a cover sheet having an adhesive layer may be pre-wrapped partially around an upper roller of a nip in order to help warm an adhesive on one surface of the cover sheet (opposite to the surface adjacent the roller) prior to its entrance into the nip. In one embodiment, a wrap extending from 30 degrees to 200 degrees is used for this pre-heating, with a more preferable wrap obtained in the range of from about 45 to 180 degrees. Lamination between nip rollers can, for example, be carried out at a temperature that is typically between about 90 and 150° C., preferably 100 to 150° C., when employing a melt adhesive. In one embodiment of a lamination step, the pressure applied at the nip is suitably in the range of 50 to 200 kiloPascals, preferably 100 kiloPascals, using a roller having a durometer of 65-70 Shore A. Control of sheet temperatures and tension is desirable to obtain good alignment between the sheets being laminated. The addition of fiducial marks or other alignment aids may also be desirable. Advantageously, either or both sheets being laminated can be provided in web form, as continuous film sheets.

The partitioned sheet and the cover sheet are preferably both made from flexible polymeric materials not comprising glass. However, glass, plastic or hybrids can be used. The sheet with the filling holes, however, preferably is not glass. In one preferred embodiment, the side walls of the microcell reservoirs can be made from a epoxide photoresist material over a polyester support.

FIG. 2B shows a second embodiment of the present process for making a ventable microcell sheet assembly 30, having filing holes 50 in the cover sheet 20, wherein an adhesive layer 15 is located on the bottom surface of the cover sheet 20 instead of on the top of the side walls of the microcells, as in FIG. 2A. It may be easier to apply an adhesive material as a more or less continuous layer on the cover sheet 20, but possible disadvantages are that the adhesive material may adversely affect optical properties to some extent or the adhesive material costs may be higher.

An advantage of the invention is that there is no problem with melted glue intermixing with imaging fluid in the microcells at this stage of the process, since the imaging fluid is not present during when the cover sheet 20 and partitioned sheet 10 are bonded together to form enclosed reservoirs 16.

In FIG. 2B, the cover sheet 20 can comprise a substrate having a patterned or unpatterned layer of adhesive, wherein the adhesive is at least located on the substrate where the cover sheet contacts the tops of the side walls 18 when forming the ventable microcell sheet assembly 30. In one embodiment, the adhesive layer 15 covers the entire cover sheet in the area of the cover sheet over the array of microcells.

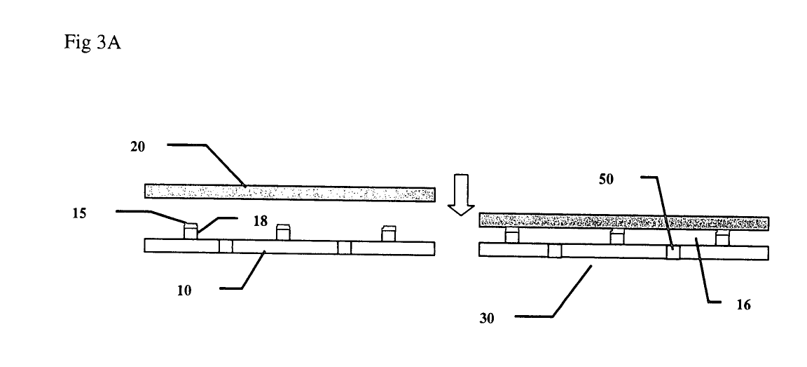

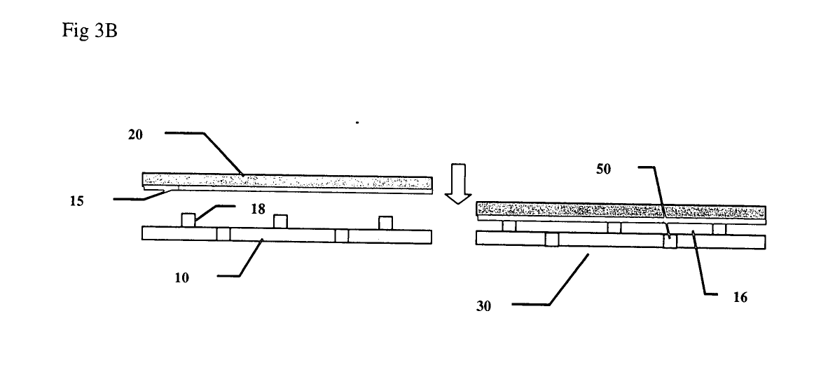

FIG. 3A shows yet another embodiment of one step in the present process in which two sheets 10 and 20 are joined together to form a ventable microcell sheet assembly 30, but in which filing holes 50 are located in the bottom (in the fig.) partitioned sheet 10. Thus the filling holes 50 can be either in the cover sheet 20 or in the partitioned sheet, or even in both, although filling holes in both may complicate the process. In the particular embodiment of FIG. 3A, the adhesive layer 15 is placed on the top surface of the microcell side walls 18 of the bottom partitioned sheet 10.

Still another embodiment for forming the ventable microcell sheet assembly 30 can employ subjecting the partitioned sheet and/or the cover sheet to a solvent that causes the two sheets to bond together by solvent action on at least one of the sheets without the use of a separate adhesive composition, after which the solvent is evaporated away. However, the term “adhesive layer” applies to any material that can be used to bond the two sheets together, including the material in the sheets themselves.

FIG. 3B shows yet another embodiment of one step in the present process in which two sheets 10 and 20 are joined together to form a ventable microcell sheet assembly 30 and in which filing holes 50 are located in the bottom (in the fig.) partitioned sheet 10. In the particular embodiment of FIG. 3B, however, the adhesive layer 15 is placed on the bottom surface of the cover sheet

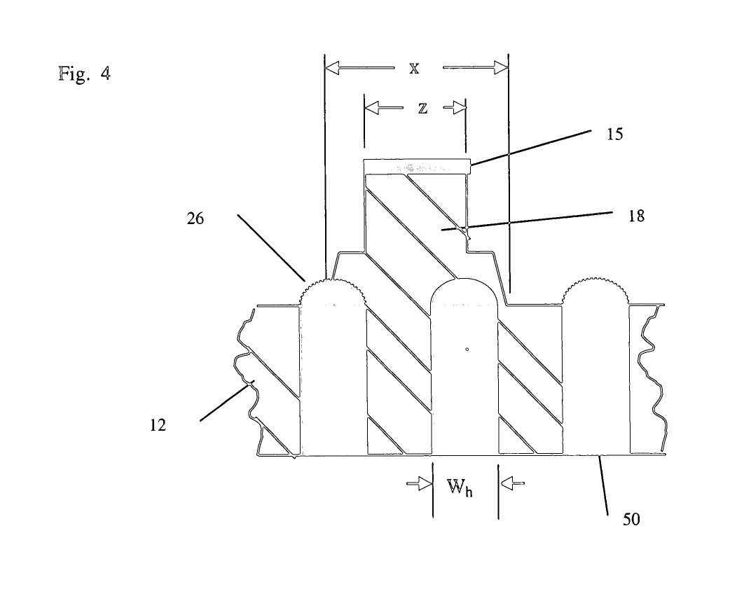

A potential problem with the approach shown in FIG. 3A or 3B is that making holes in partitioned sheet 10 can pose the danger of breaching the side walls 18 separating microcells. One way of eliminating such a danger is to fabricate microcell side walls as shown in the embodiment of FIG. 4.

FIG. 4 shows a cross-section of a microcell side wall 18, with adhesive layer 15 on the top surface, extending vertically from bottom wall or support 12 of a partitioned sheet, showing hole diameter wₕ for each of the filling holes 50 formed in the bottom wall, for example by means of a laser, in relationship with the cell lower side wall width x, so that an individual filing hole cannot possibly access two separate adjacent microcell reservoirs simultaneously. Obviously the lower side wall width x is greater than the hole diameter wₕ, even though microcell upper side wall width z may be less than the hole diameter wₕ, which may be desirable. The hole diameter must not be so wide as to open access between two cells. The filing holes 50 that successfully penetrate the bottom support 12, forming hole penetration envelope 26 can serve as filling holes.

The filling holes can be formed by various methods, including laser drilling, electrostatic perforation, mechanical perforation, track etch, chemical etch, stretching, or other techniques for making holes in a sheet material. Laser is a preferred modality due to the ability to control the quality of the formed hole geometry, programmability of patterning, and manufacturing speed. Excimer laser, Yag laser, and other laser types can be used depending on the performance desired and material being drilled. A variety of wavelengths can be employed depending on the material being used and desired final geometry. Excimer lasers are particularly well adapted for drilling well-formed hole geometries in polymers such as PET, Cellulose Triacetate (CTA), and other polymeric materials suitable for use in electro-optical modulating displays. Various wavelengths of laser light are available that provide different levels of performance and capability depending on the requirements. The excimer laser operates via pulsed material ablation and can be controlled to precise depths by controlling the number of pulses and power applied to the material. A 193-nm UV wavelength excimer laser can drill precisely formed 10-micrometer holes on a 30 micrometer pitch, for example, in a 2-10 micrometer thick CTA sheet cast onto a 150 micrometer PET (polyethylene terephthalate) carrier with minimal penetration into the carrier substrate. Additionally, dopants can be added to the substrate material being drilled. A dopant such as TINUVIN 8515 manufactured by Ciba can improve a material's preference for absorbing or rejecting a specific laser wavelength, allowing for improved performance in drilling, selectivity in drilling on composite materials, and allowing the use of longer wavelength laser systems that are typically less expensive to own and operate.

The laser processing preferably provides a hole in the coated cover sheet that is without uplifts around the hole rim, typical of laser drilling by CO₂ lasers in PET. These uplifts can inhibit fluid flow into the cell via the drilled hole. Use of an excimer laser, which have a smaller beam size, would provide for a less visible hole structure, smaller diameter holes and smaller pitch in a variety of polymer materials. Lasers may be used in conjunction with a mask.

For example, 25 micrometer diameter holes can be drilled through a 50 micrometers thick PET substrate at a minimum center-to-center spacing of 35 micrometers, using a 193-nm excimer laser.

Preferably, when the filling holes are in the partitioned sheet, the laser power is controlled and/or the shape and thickness of the walls are pre-designed, for example as shown in FIG. 4, such that the laser is able to penetrate the bottom wall of the microcells but is unable to break the side walls between adjacent microcells irrespective of where the laser is applied to the bottom of the partitioned sheet.

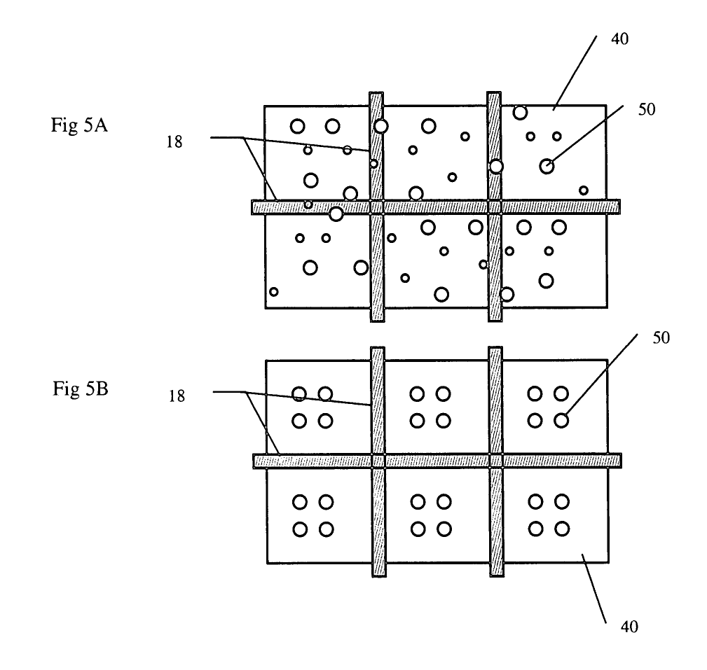

FIG. 5A shows a plan view of one embodiment of a hole-patterned sheet 40 (for example, either partitioned sheet 10 or cover sheet 20) in which filling holes 50 are random. The diameters of the holes and/or their pitch can vary. The shapes of the holes can vary. The length dimension of the hole diameters, however, is preferably not greater than the width of the side walls 18, particularly for holes randomly placed. Also, holes should not intersect or contact one another.

FIG. 5B shows a plan view of a second embodiment of hole-patterned sheet 40 in which holes 50 are non-random. The length dimension of the hole diameters, again however, is preferably not greater than the width of the side walls 18, although the holes for each microcell are designed for placement at a distance from the side walls. For the non-random pattern, the hole diameter, shape, and pitch can also vary. Also, holes should not intersect or contact one another.

In FIG. 5B, the hole-patterned sheet has a pattern of filling holes in which a plurality of filling holes corresponding to each microcell form concentrated areas of filling holes, each area separated from the others by a pre-determined length, the minimum spacing between concentrated areas of filling holes preferably being greater than the width of the side walls of the microcells. The concentrated areas of filling holes can form a rectangular or other shape.

As indicated above, the process next involves (A) subjecting the array of microcells in the ventable microcell sheet assembly to a vacuum in order to evacuate each microcell in the array of microcells, thereby obtaining an evacuated microcell sheet assembly; and (B) temporarily sealing each of the microcells in the array of microcells by forming a temporary seal over the one or more filling holes in each microcell while maintaining a vacuum inside the microcell. In particular, the process can involve covering the filling holes in the cover sheet or the partitioned sheet, as the case may be, with a temporary sealing sheet by, respectively, adherently contacting the cover sheet or the partitioned sheet comprising the filling holes with a temporary sealing sheet or layer. The sealing interface, including the material surfaces and adhesive, must provide an effective temporary seal of the area between and around the holes to prevent loss of vacuum in the microcells. A temporary sealing sheet can comprise, for example, an adhesive layer on a substrate, or a temporary sealing sheet can consist of, in whole or in layered part, a vacuum sealable tacky plastic material. The term “adhesive” refers to a tacky substance capable of holding two materials together. The permanency of the bond created by an adhesive may vary based on the type of adhesive used. Additionally, a temporary sealing sheet may be held in place by other attractive forces such as electrostatic adhesion, cohesion, diffusive adhesion, and/or dispersive adhesion.

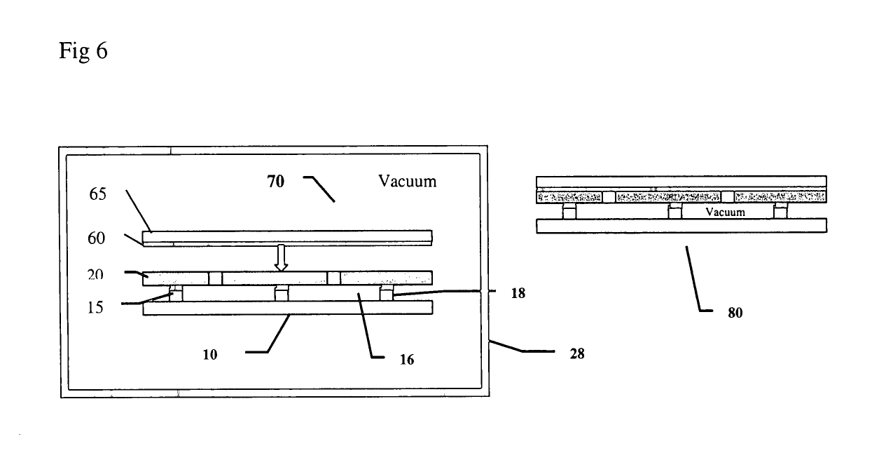

FIG. 6 shows one embodiment of the process steps of (A) evacuating the microcell reservoirs 16 between side walls 18 in partitioned sheet 10, while the structure is in a vacuum chamber 28, and subsequently, (B) temporarily sealing the filing holes in cover sheet 20 with a temporary sealing sheet 70, for example, comprising a temporary substrate 65 having, on one side thereof, temporary adhesive layer 60, to form a temporarily sealed evacuated microcell sheet assembly 80. This could be accomplished, by a roll-to-roll lamination process, in a vacuum chamber similar to industrial-scale sputter chambers. Effective bonding in the assembly, at both levels of adhesive 15 and 60 is desired in order to prevent edge seal leaks and loss of vacuum in the microcells.

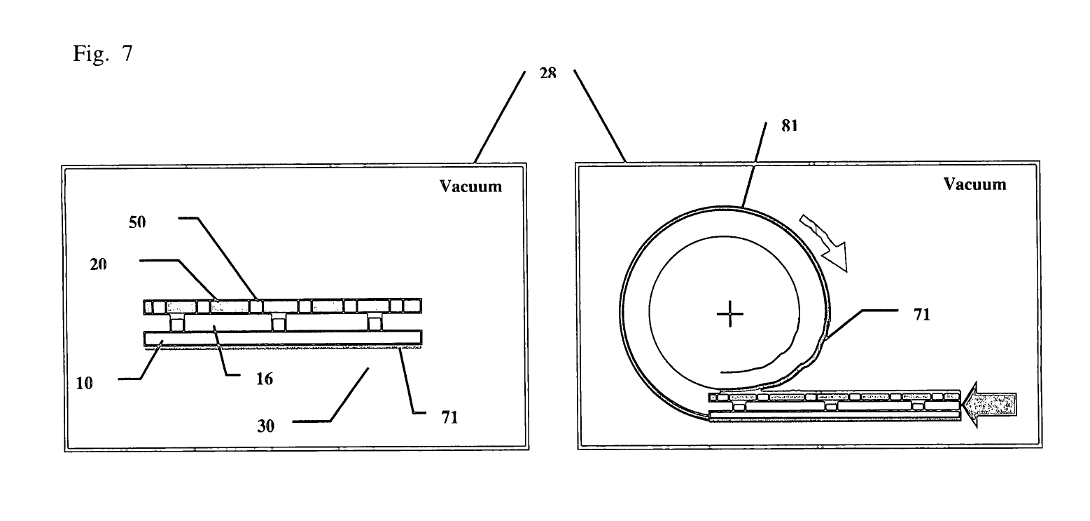

FIG. 7 shows an alternative embodiment of the process steps of FIG. 6 that likewise involves evacuation of the microcell reservoirs 16, formed by sheets 10 and 20, while the structure is in a vacuum chamber 28, but in which the partitioned sheet 10 has a tacky sealing layer 71 facing away from the assembly 30. Alternatively, the tacky sealing layer 71 can be part of the cover sheet 20 or can be applied to the bottom of partitioned sheet 10 at a suitable stage of manufacture or the support of partitioned sheet 10 can entirely be made of a tacky material. The tacky sealing layer 71 or sheet needs to be capable of temporarily holding a vacuum when applied to a surface and does not necessarily need to be an adhesive material such as a glue composition or the like. Subsequently, temporary sealing of the pattern of filling holes 50 with the tacky sealing layer 71 is accomplished when the tacky sealing layer or sheet and assembly 30 are wound simultaneously into a roll 81 within the vacuum chamber 28 to form a temporarily sealed evacuated microcell sheet assembly in roll format.

Thus, in the embodiment of FIG. 7, a tacky sealing layer that is integrally part of the partitioned sheet and forms the lower surface thereof, on the side opposite the cover sheet, can be used to temporarily seal the filling holes on the cover sheet when the evacuated ventable microcell sheet assembly is rolled up. Alternatively, the tacky sealing layer is a film or sheet separate from the evacuated ventable microcell sheet assembly and seals the filling holes when it is simultaneously rolled up adjacent to the side of the evacuated ventable microcell sheet assembly. Still alternatively, a tacky sealing layer or sheet can be laminated to the evacuated ventable microcell sheet assembly in a nip under pressure optionally at an elevated temperature just prior to it being wound into a roll.

The filling and permanently sealing of the temporarily sealed and evacuated microcells must next be accomplished. As indicated above, the process at this stage comprises (A) removing the temporary seal and filling each of the microcells in the array by drawing an electro-optical imaging fluid, under relative pressure to the vacuum, into the microcell, for example, while the microcells are immersed in the electro-optical imaging fluid in a tank under atmospheric pressure, and (B) permanently sealing the filling holes to completely enclose the electro-optical imaging fluid in the microcells, for example with a unitary (integral) sealing sheet placed over the filling holes. The imaging fluid can also be above or below atmospheric pressure, so long as it is sufficiently higher than the pressure in the vacuum.

In other words, the temporarily sealed evacuated microcell sheet assembly can be filled via the filling holes with the electro-optical imaging fluid by removing the temporary sealing sheet while substantially simultaneously allowing the imaging electro-optical imaging fluid under relative pressure to enter the microcells through the filling holes, thereby forming a sheet assembly comprising an array of filled but unsealed microcells. After the assembly containing the filled by unsealed microcells is transported out of the electro-optical imaging fluid, it is permanently sealed, for example, by using a permanent sealing sheet placed over the filling holes to sealingly enclose the electro-optical imaging fluid in the array of microcells. The assembly containing the filled but unsealed microcells can, for example, be laminated with a permanent sealing sheet in a nip under pressure optionally at an elevated temperature.

When the unsealed filled microcell sheet assembly emerges from a pool of electro-optical imaging fluid held in a tank or other container, any excess electro-optical imaging fluid is preferably removed or cleaned from the surface of the sheet assembly prior to application of a permanent sealing sheet.

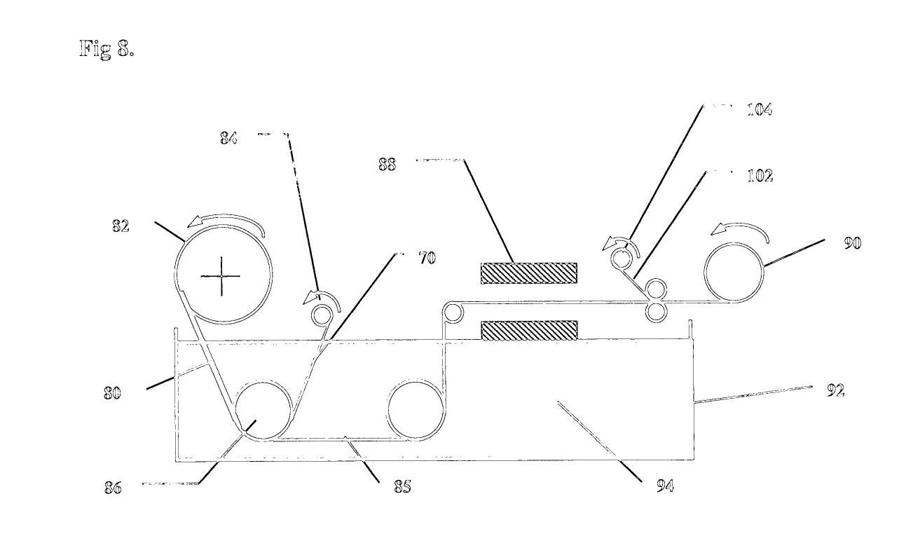

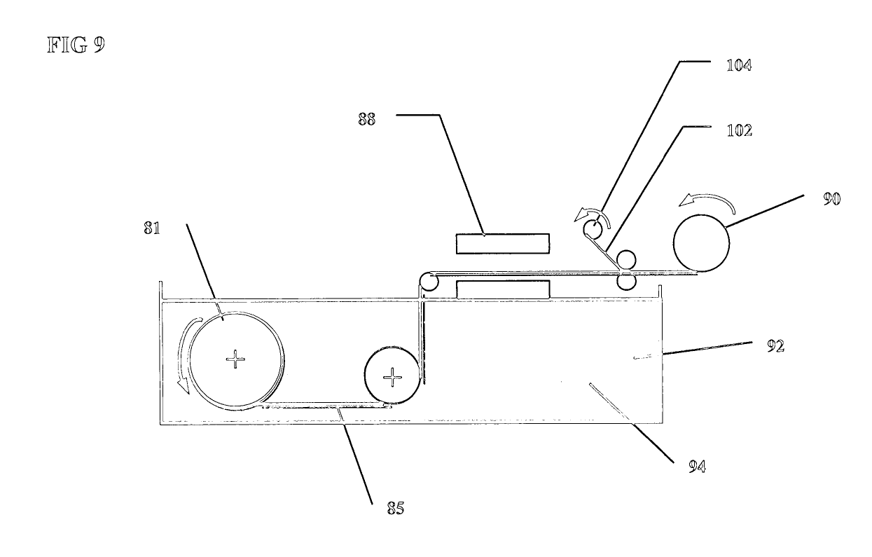

FIG. 8 shows one embodiment of filing and permanently sealing the temporarily sealed evacuated microcell sheet assembly 80, as it is unwound from supply roll 82 using an imaging fluid tank 92 containing imaging fluid 94, and removing a temporary sealing sheet 70, via peeling roller 86, onto windup roll 84. Removing the temporary sealing sheet 70 within the tank exposes the evacuated reservoirs or chambers of the microcells to imaging fluid, which rushes in to fill the chambers.

After the unsealed filled microcell sheet assembly 85 emerges from the imaging fluid in the tank, a cleaning station 88 may be employed for cleaning and/or de-oiling the assembly, especially the hole-patterned surface, which can involve removing oil, carrier fluid, particles or other materials or contaminants from the surface to be permanently sealed. Excess fluid can be removed, for example, by a scraping means, wiping, draining with gravity, air knife and/or absorbent wiper. Capillary action can potentially hold imaging fluid in a microcell filling holes, and the surface should preferably be cleaned prior to any subsequent contact or lamination step involved in permanently sealing it with, for example, a permanently sealing sheet 102 from second supply roll 104. This sheet 102 provides a permanent seal over the filling holes in the sheet assembly 85 to form permanently sealed microcell assembly 90.

FIG. 9 shows an alternate embodiment of filing a temporarily sealed evacuated microcell sheet assembly 80 that is in the form of roll 81. This embodiment also uses an imaging fluid tank 92, cleaning station 88, and involves permanent sealing with a permanent sealing sheet 102 from second supply roll 104. However, a rolled-up sheet assembly 80 such as shown in FIG. 7 is used, in which process roll 81 is submerged in the imaging fluid 94 in the tank 92. Unwinding the roll 81 exposes the imaging fluid to the filling holes leading to the evacuated chambers. The vacuum draws the imaging fluid into the microcells to fill the chambers thereof. Thus, the temporarily sealed evacuated microcell sheet assembly in process roll 81 is unwound while immersed in the imaging electro-optical fluid such that merely the unrolling of the assembly unseals the microcells in the assembly.

In one embodiment, the electro-optical imaging fluid 94 in the Tank 92 can comprise charged particles dispersed in a carrier fluid. The particles can be solid materials or liquid materials. Preferably, the carrier fluid is transparent or colored organic dielectric fluid, more preferably an organic dielectric fluid having a long chain hydrocarbon or paraffin, optionally halogenated. Dry particles may be used as the imaging fluid, not necessarily dispersed in a liquid, in which case the tank 92 can be completely enclosed. Those dry particles may be filled into the microcells while dispersed in a temporary solvent that is subsequently evaporated by heat of vacuum, leaving the dry particles to populate the microcells without liquid fluid.

Particularly when filled the microcells with a liquid carrier fluid, it may be desirable to expunge any gas bubbles that may form in the microcells during filling due to incomplete filling from a variety of reasons including surface tension effects which can bow the flexible cover sheet toward the fluid in the cell creating areas in the corners of the cell without access to a fill hole for venting. Gas bubbles may degrade the cell optical performance and reliability, depending on the bubble size, constituent gas in the bubble, and location in the cell. Preferably no bubbles will be formed. If bubbles form they can be removed or minimized with techniques such as exposing a microcell immersed in imaging fluid to a low vacuum once it is filled and before sealing, heating the cell to expand the bubble and force it out a filling hole, and manipulating the microcells to force the bubbles toward a vent hole. Manipulation can occur, for example, by varying the position of the microcell sheet assembly, such as by running the microcell sheet assembly over a series of reversing rollers arranged to form a serpentine transport path. The microcell sheet assembly cover sheet with filling holes can also be compressed slightly, such as in a nip roller, or by flexure over a support roller that puts the cover sheet in tension while the sheet assembly is immersed in the imaging fluid. In both cases the microcell volume is reduced, forcing the gas bubbles toward the filling holes, now functioning as vent holes, while under compression. The volume of the microcells once occupied by the gas bubbles are then refilled with imaging fluid once the compression is relaxed.

In addition to processing after filling, the use of filing holes with relatively smaller hole pitch and smaller diameter holes tend to eliminate remaining air bubbles.

Another aspect of the invention, as indicated above, is directed to an electro-optical modulating display, which optionally may be made by the above-described process or the like, which display further comprises an electrical driver for providing control of electrical switching of the optical state of the electro-optical fluid in each microcell in the array. The first sheet comprises a patterned element having optical or electrical functionality associated with individual microcells of the array, which patterned element can comprise a mask, to hide charged particles in the electro-optical fluid, thereby enhancing contrast. The patterned element can also comprise bus bars, collector electrodes, gate electrodes, flag electrodes, and/or electrode pad areas. Suitably the patterned element is positioned in regions all or partially under the array of microcell reservoirs of the first sheet. The second sheet can optionally have windows as described above. Preferably the array of microcells is rectangular in shape and the flat border area in the first sheet forms a rectangular frame around the array.

In particular, as indicated above, the electro-optical modulated display comprising an array of microcells each sealingly filled with an electro-optical imaging fluid, the display comprising:

(a) a first sheet comprising an array of microcell reservoirs, each microcell reservoir being no longer than 1000 μm along any dimension thereof, each microcell reservoir formed by side walls extending vertically from a lower substrate and containing an electro-optical imaging fluid;

(b) a second sheet laminated to the first sheet, the second sheet covering each of the filled microcell reservoirs in the array, wherein the second sheet is bonded to the tops of the side walls of each microcell reservoir in the array, wherein either the first sheet or the second sheet comprises a plurality of sealed filling holes such that one or more of the plurality of sealed filling holes is associated with each microcell in the array, and wherein the sealed filling holes in each of the microcells in the array have been commonly sealed by a unitary layer of material; and

(c) an electrical driver for providing control of electrical switching of the optical state of the electro-optical imaging fluid in each microcell in the array.

Various patterns can be used for the filling holes. For example, the vent-forming sheet can be formed with a uniform pattern of filling holes, each a substantially uniform size and distance from each other and each preferably smaller in diameter than the wall thickness. Alternatively, the vent-forming sheet comprises filling holes that are of a diameter at least 5×, preferably at least 10×, the median diameter (equivalent diameter) of the largest system particles, to allow ease of filling, and no greater than the width of the microcell side wall base, for example x in FIG. 4, when employing holes in the partitioned sheet 10, or support thereof 12, and no greater than microcell wall top width z when employing holes in the cover sheet 20.

For example, in one embodiment having 1-micrometer particles and 5-micrometer holes, a fill-hole area is provided that is at least 19× the projected area of the particle for filling purposes. In another embodiment, a 10-micrometer hole provides a fill area of 78× that of the projected area for 1-micrometer particles.

In one embodiment, the vent-forming sheet comprises filling holes that are separated by a distance that provides for at least one hole per microcell, typically a distance less than the length of the repeating pitch of the microcells, y in FIG. 1 and preferably by a distance at least greater than 3× the hole diameter for patterned holes.

In another embodiment, the vent-forming sheet has a random pattern of filling holes wherein each does not have a substantially uniform size and distance from each other, however, wherein each is smaller in diameter than the wall base x for holes in a support 12 and no greater than microcell wall top width z for holes in the cover sheet 20

The total hole area preferably is in the range of 15 to 20% of the total microcell area in plan view, more preferably 3 to 8%. (The low end allows for 1-10 micrometer hole in a 100×100 micrometer microcell.)

The filling holes may be perforations formed during the manufacture of the cover sheet material itself without the manufacture of a corresponding unperforated sheet, for example by stretching. Such perforations can be formed after the manufacture of a corresponding unperforated sheet. The vent-forming sheet can have a pattern of filling holes in which a plurality of filling holes corresponding to each microcell forming concentrated areas of filling holes, each area is separated from the other by a minimum spacing less than the pitch Y, in plan view, of each microcell. The minimum spacing between concentrated areas of filling holes allows for greater alignment tolerance than the typical width of the side walls of the microcells. Preferably, the concentrated areas of filling holes are in rectangular shape, although other shapes can be used. Pitch can be different in different orthogonal directions.

The electro-optical modulated display can further comprise a patterned element having optical or electrical functionality associated with individual microcells of the array that provides a functionality selected from a the group comprising a mask designed to hide particles in the electro-optical fluid, bus bars, collector electrodes, gate electrodes, flag electrodes, electrode pad areas, and combinations thereof.

Regarding the partitioned sheet in FIG. 1, the support 12 with array 14 can be made in a variety of ways. One embodiment employs a pre-patterned temperature controlled roller, the cylindrical surface of which has been patterned with a continuous array of micro-cells that contain both male and female features. The pattern on the temperature-controlled roller is formed in a seamless manner. A molten polymer such as polyolefin, PMMA, polycarbonate, or TAC is extrusion cast onto the temperature controlled roller from a melt extruder. The molten polymer may be cast first onto the patterned temperature controlled roller and then brought into a nip formed with a pressure roller or the molten polymer may simultaneously contact both rollers. Molten polymer may be extruded directly into the nip formed by the patterned roller and the pressure roller or the melt stream may be offset slightly to contact the pressure roller first. The nip pressure aids in forcing the molten polymer to conform to the features on the pattern temperature controlled roller surface. The mass of the polymer is such that there is an excess amount that forms an integral stiffening member to the pattern feature, therefore eliminating the need for a transfer sheet.

The molten polymer may further comprise melt additives to provide melt stability, release agents to aid in the removal of the sheet from the temperature controlled roller surface, or UV absorber to help protect the electro-optic materials that are used to form colors in some types of display.

A support sheet formed from an extrusion roll molding (ERM) process can have certain advantages over UV cured sheets. The ERM sheet has improved clarity, improved stiffness and does not have to undergo a slow radiation-curing step. A wide variety of extrusion grade polymers may be used. The ERM process typically is much faster than a UV curing process.

The ERM process differs from hot stamping or embossing in a number of important aspects. Hot stamping and embossing apply heat and or pressure to a preformed sheet or substrate. The heat and pressure is used to allow the preformed sheet to taken on the form of the desired pattern formed into the surface. The preformed sheet undergoes a cold flow process that freezes stresses and strains into the sheet. Typically such sheets have poor lay-flat properties and appear to be wavy and have curl. In contrast, surface patterns that have been formed by hot stamping or embossing are very difficult to fill and seal for use in electro-optic displays.

In the ERM process, the base polymer is melted and the viscosity of the resulting molten polymer is able to replicate the pattern of complex surfaces such as associated with an array of microcells. The heated polymer is then quenched to freeze the polymer into the desired pattern. Sheets formed by ERM are less prone to waviness and curl and therefore are easier to handle during filling and sealing.

Additional integral layers may be coextruded simultaneously or extruded in two or more sequential extrusion processes within the same or different manufacturing line. In an ERM process using two or more layers, the layer in direct contact with the temperature controlled roller may have properties that improve replication of the desired pattern, improve chemical resistance to the electro-optic materials that will be used to fill the micro-cell pattern, or provide improved sealing to a secondary sealing sheet. The other layer(s) may use the same or different polymers than the layer that contacts the temperature controlled rollers. If a different polymer is used it may be advantageous to use a material that can provide improved stiffness that helps to support the display cells or has improved flexural resistance for bending or conformance. It may be advantageous to use a polymer that has improved durability, scratch resistance, or toughness for an external surface. Polymer selection may also consider factors for improved light transmission. This may include, but is not limited to, optical clarity, refractive index matching or step gradings to minimize optical losses at the interfaces between layers, air or electro-optic materials. The polymer layer may further contain polymers or materials to enhance water vapor barrier properties as well as gas barriers such as oxygen and ozone that may affect colorants in the display. Multi-layer improvements may be difficult when using a UV cast/curing process.

In another embodiment, additional layers may be applied to either one or both sides of the ERM formed sheet. These layers may include but are not limited to anti-reflection layers, anti-smudge or fingerprint layers, hardcoats, antistatic layers, adhesion promoting layers or patterns, UV absorber layers, layers containing indicia such as logos, trademarks, or security protection, and/or gas barrier layers for contaminants such as water, oxygen and others.

In a further extension of multi-layer extrusion roll molding, two layers may have different thicknesses and or may have the ability to be detached or separated from each other. In this manner, an integral carrier layer can be formed simultaneously with microcell array 14 as opposed to applying it after microcell reservoirs 16 have been formed. With such an arrangement, the bottom supporting layer may then be removed to from a very thin micro-cell array. Control of the thickness of the micro-cell array may be important when a conductive layer or pattern is attached directly below the cell. Being able to provide a very thin polymer layer between the conductive layer and the electro-optic fluid in the microcell tends to provide improve control of the fluid.

The choice of polymer to be used in the ERM process has many considerations. This may include but is not limited to the polymer's chemical makeup such as its molecular weight distribution, its relative amount of crystalline and amorphous regions prior to melting as well as the final properties desired to provide good replications, adequate dimensional stability, chemical resistance to the electro-optic materials, electrical charge retention, and management on the polymer surface and within its bulk, and overall stiffness to minimize warpage under varying environmental conditions. Some difficulties may occur in providing the optimal level for all these parameters from a single material. It may be advantageous to provide additional surface treatments by coating or applying other materials to all or part of the surfaces of the replicated micro-cell array. This may include thin dielectric materials to minimize charge injection or sticking of particles on the cell wall surface. Other possible modifications may include the use of one polymer to form the micro-cell and another polymer or blend of polymers to form the non-microcell side of the cast sheet. This is useful in providing a material that is thicker, provides additional stiffness, toughness and or dimensional stability. Anti-reflection layer, hardcoats, or static control layers may be applied by coating or laminating to the desired side of the array sheet. A two-layer structure of this nature may be provided by coextruding two layer of molten polymer simultaneously using two separate extruders and joining the two polymer flows in a feedblock of multi-cavity die. The thickness of the two melt streams can be varied and, therefore, when one of the two polymers touches the moving mold with male and female features only that polymer forms the feature and the other side may touch a smooth mold feature so as to replicate a smooth surface on that side. In such a means of making a micro-cell array, different physical and or optical properties can be made within the array sheet. A different embodiment of forming an array sheet with different properties on each side would be to form the array in a one polymer and melt casting and adhering it on a pre-formed polymer sheet. In this manner the polymer sheet becomes a part of the cell array structure. If the relative bond level between the pre-formed polymer sheet and the melt cast polymer features is controlled, it is possible to make very thin micro-cell arrays that can be removed from the pre-formed polymer sheet and attached to a different material. An additional embodiment would be to melt cast the array as a thin sheet and then adhesively adhere a second sheet to it by applying and adhesive and laminating the array and sheet together in a pressure nip or by melt casting a second polymer layer to the smooth side of the array sheet.

Extrusion roll molded micro-cell arrays can be formed in a continuous roll process. For example, in one embodiment, polycarbonate, PMMA, which can be purchased in pellet form and is dried to remove any surface moisture that may have absorbed or condensed onto the surface, is conveyed into a hopper that is used to feed a melt extruder. A feed screw rotates inside a barrel and external heat is applied to help melt the resin. This process forms a viscous fluid melt of the polymer. The resin is conveyed through the screw and barrel and may enter different sections to assure full melting and temperature uniformity of the melt. The molten polymer may then be filtered to removed any unwanted materials or gel-like slugs. The molten resin is then pumped into a die cavity that enables the melt stream to be distributed across the width of a support sheet. As the melted polymer exits the die, it drops either onto a temperature controlled roller surface with the desired pattern and then into a nip or directly into a nip formed by the temperature controlled roller and another roller. The viscosity of the molten resin as well as pressure in the nip are adjusted to assure good replication of the desired pattern as well as the formation of integral thickness to the cast sheet that adds strength and stiffness that allows the sheet to be conveyed, coated, laminated or wound in roll form. This avoids the need to provide a separate plastic substrate or transfer sheet that is needed for certain UV or epoxy cast microcell displays.

Useful polymers for the ERM process are typically those that have a relatively high molecular weight and can withstand melt temperature in excessive of several hundred degrees. Typical polymers may include extrusion coatable grades or blends of polycarbonate, polymethylmethacrylate, polyethylene terephthalate, polyethylene naphthate, polyolefin, cyclic olefins, cellulose acetate, ethylene vinyl acetate, polyimides and copolymer derivatives thereof.

While the ERM process described above can be used to provide molded structures useful in this invention, photoresist materials (UV monomers or epoxies) can also be used to provide an alternate means of forming a microcells without the need to provide an expensive mold. In such a process, a radiation sensitive material such as SU-8, a photosensitive epoxy material manufactured by MicroChem Corp. (Newton, Mass.) may be coated onto a web and provided with a soft bake to remove some of the solvents present in this material. The photosensitive material is then exposed to the desired radiation source (UV in this case) using a mask to prevent exposure and subsequent crosslinking in areas where there is no wall. The exposed material is then baked in a dryer and a development/wash step is performed to remove the residual unexposed material thus forming an array of microcells. This method eliminates the need for a mold and the photosensitive material may be coated onto a web with a pre-pattern of electrodes. This is an additive-type step that eliminates the need for critical alignment when the electrodes need to be position within each cell. Furthermore, this process allows the walls to be built onto most any substrate. For instance, if the display (either during manufacturing or in final use) is expected to be exposed to an environment in which the temperature and or humidity is severely cycled, it may be desirable to coat the photoresist material onto an oriented and or heat-set and or heat-relaxed web that has improved dimensional and thermal properties. This provides a more robust display and will help to minimize seal failures. It provides an opportunity to treat or prime the web prior to coating to enhance the adhesion between the web and the photosensitive material. Methods may include, but are not limited to, chemical primers such as polyethyleneimine, various latexes such as acrylic, acryl ate, and copolymers derivates thereof. Web treatment may include, but is not limited to, corona discharge, atmospheric modified corona, as well as vacuum plasma treatments.

A multi-colored electro-optical modulating display, if desired, can be prepared by filling and sealing one microcell array with one electro-optical imaging fluid color, and repeating this process using a second and third colored electro-optic imaging fluid. In one embodiment, a multi-colored display is formed by stacking two or more filled and sealed sheets to one another so that display devices are deployed in a vertical stack. Such a display can have improved color saturation and may be able to replicate more colors. Proper alignment is advisable to assure that the viewing region in each microcell array is aligned with the others.

In a preferred embodiment, the electro-optical imaging fluid used in the array of microcell reservoirs can be bistable, so that it forms an image when addressed with an electric field and then retains its image after the electric field is removed. Particularly suitable electro-optical imaging fluids that exhibit “bistability” include many types of electrochemical materials, electrophoretic fluid materials, fluids containing GYRICON particles, electrochromic fluids, magnetic materials, or chiral nematic liquid crystals.

The electrically modulated fluid material may also be a printable ink having an arrangement of particles or microscopic containers or microcapsules. Each constituent microcapsule can itself contain an electrophoretic composition of a fluid, such as a dielectric or emulsion fluid, and a suspension of colored or charged particles or colloidal material. The diameter of such constituent microcapsules typically used for this purpose generally ranges from about 30 to about 300 microns. According to one practice, the charged particles in such constituent microcapsules visually contrast with the surrounding dielectric fluid. According to another example, the electrically modulated material may include rotatable balls that can rotate to expose a different colored surface area, and that can migrate between a forward viewing position and/or a rear non-viewing position. One example of this type of imaging mechanism is the GYRICON technology that had been developed at one time by Xerox Corporation, Stamford, Conn. In the GYRICON device, a material was comprised of twisting rotating elements contained in liquid filled spherical cavities and embedded in an elastomer medium. The rotating elements were made to exhibit changes in optical properties by the imposition of an external electric field. Upon application of an electric field of a given polarity, one segment of a rotating element would rotate toward an observer of the display. Application of an electric field of opposite polarity would cause each element to rotate and expose a different segment to the observer. The bistable GYRICON display would maintain a given configuration until an electric field was actively applied to the display assembly. GYRICON particles typically have a diameter of about 100 microns. GYRICON materials are disclosed in U.S. Pat. No. 6,147,791, U.S. Pat. No. 4,126,854 and U.S. Pat. No. 6,055,091, the contents of which are herein incorporated by reference.

According to one practice, the microcell reservoirs of a display device may be filled with electrically charged white particles in a black or colored dye. Examples of electrically modulated materials and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898, the contents of which are herein incorporated by reference.

The electrically modulated electro-optical imaging fluid may also include material disclosed in U.S. Pat. No. 6,025,896, the contents of which are incorporated herein by reference. This material comprises charged particles in a liquid dispersion medium encapsulated in a large number of microcapsules. The charged particles can have different types of color and charge polarity. For example, white positively charged particles can be employed along with black negatively charged particles. The described microcapsules are disposed between a pair of electrodes, such that a desired image is formed and displayed by varying the dispersion state of the charged particles. The dispersion state of the charged particles can be modulated using a variably controlled electric field applied to the electrically modulated material. According to a preferred embodiment, the particle diameters of the microcapsules are between about 5 microns and about 200 microns, and the particle diameters of the charged particles are between about one-thousandth and one-fifth the sizes of the particle diameters of the microcapsules. The microcells switch rapidly between two optically distinct, stable states simply by alternating the sign of an applied electric field.

Those skilled in the art will recognize that a variety of light-modulating electro-optical imaging materials are available and may be used in the present invention. The light-modulating material employed in connection with the present invention, is preferably bistable, not requiring power to maintain display of indicia, at least for a suitable period of time. Such devices, since they do not require a continuous driving circuit to maintain an image, exhibit significantly reduced power consumption due to their non-volatile “memory” characteristic.

A light-modulating electro-optical imaging fluid may be formulated to have a single color, such as black, white, or clear. The particulate components may be fluorescent, iridescent, bioluminescent, incandescent, or may include a wavelength specific radiation absorbing or emitting material for visible, ultraviolet, infrared light. There may be multiple layers of light-modulating material. Different layers or regions of the electrically modulated material may have different properties or colors. Moreover, the characteristics of the various layers may be different from each other. For example, one layer can be used to view or display information in the visible light range, while a second layer responds to or emits ultraviolet light.

A variety of adhesives can be used as the adhesive layer 15 (FIGS. 2A, 2B, 3A, and 3B). In one embodiment, a polyester-type thermoplastic polyurethane (TPU) is used. Other adhesive materials include, but are not limited to amorphous or semi-crystalline copolyester resins, ethylene vinyl acetate (EVA) or styrene acrylonitrile (SAN) copolymers, or polychloroprene or chlorosulfonated polyethylene. These adhesive materials are typically applied from organic solvent solution at a dry layer thickness of one to ten micrometers. In the case of a melt adhesive, the temperature that the adhesive layer during lamination achieves can be suitably adjusted.

The invention has been described with reference to preferred embodiments. However, variations or modifications of these embodiments can be devised by a person of ordinary skill in the art without departing from the scope of the invention. Thus, what is provided is a particularly advantageous structure for an electro-optical modulating display and, independently, a method that may be used for fabrication of a variety of electro-optical modulating displays comprising an imaging fluid arranged in an array of sealed cells.

The invention has been described with reference to a preferred embodiment. However, it will be appreciated that variations and modifications can be effected by a person of ordinary skill in the art without departing from the scope of the invention.

### EXAMPLE

A demonstration microcell assembly was prepared and filled using the following materials and steps. A 50 micrometer PET (polyethylene terephthalate) coversheet was evenly coated in a thin layer (approximately 0.5 mils) with VITEL 2700 copolyester adhesive. VITEL is a coatable, thermally activated adhesive resin manufactured by Bostik Corp. The adhesive resin was dissolved in an organic solvent such as methyl-ethyl ketone for coating. The cover sheet was then drilled with an array of through holes that extended through the cover sheet and adhesive layer. The through holes were drilled with a Model #57-1 CO₂ laser made by Synrad (IR wavelength). The power was attenuated with a filter with less than 0.20 watts of power at the focus of the beam. The beam was controlled or positioned using galvos. The through holes were drilled to a mean diameter of approximately 125 micrometers in a rectangular grid spaced at 500 micrometers by 500 micrometers. The hole diameter and spacing of the example were limited by the laser and optics systems and were not optimized for commercial practice.

The cover sheet was then applied over a repeating microcell structure located on one side of a polyester substrate. An array of individual cells each approximately 200×200 micrometer square was formed on one side of a polyester substrate using SU-8 photoresist (manufactured by MicroChem, Inc.), more particularly SU-8 2010 series (Y111058) manufactured by MicroChem, Inc. A layer of approximately 10 micrometers was spun coated at 3000 PRM.

The sample is pre-baked for approximately 3 minutes at an elevated temperature of approximately 65° C. A photo mask was prepared separately using Kodak Direct Image Setting Film (available from Eastman Kodak Company) and laser writing a cell pattern in which the wall areas for the micro-cell walls are clear on the mask film. The mask was placed over the top of the spun photo-resist and exposed using UV light for 120 seconds. The sample was then post-baked for 3 minutes and then developed using MicroChem SU 8 Developer (Y020100) for 2 minutes. The sample was then rinsed for 30 seconds using isopropanol and then air dried. When completed there is a wall structure of microcells that is capable of containing liquid. The depth is approximately 10 micrometers and the microcell walls are approximately 20 micrometers wide.

The top cover sheet with the adhesive and through holes was thermally laminated to the top of the side walls of the microcell array. Minimal pressure and temperatures were required to prevent the adhesive from filling the cells. This integrated structure resulted in microcell reservoirs (empty) being formed by the volume enclosed by the cover sheet, microcell walls, and microcell grid substrate (floor). This arrangement did not allow for smaller holes or multiple holes per cell, but provided a suitable structure for testing, that is, an integrated microcell assembly with holes in the cover sheet providing access to the as formed microcell reservoirs.

The integrated microcell assembly was placed into a vacuum chamber and a vacuum was applied. The vacuum level was drawn down to medium vacuum less than 1 Pa.

A piece of adhesive tape with low bond strength (3M transparent SCOTCH 3750) and non-permeable to gas was applied to the cover sheet in the vacuum chamber, thereby sealing off the holes in the cover sheet and maintaining a negative pressure inside the cells of the assembly when it was removed from the chamber. The vacuum chamber was then equilibrated to atmospheric pressure and the composite microcell structure was removed. The microcell structure was then placed in a container containing imaging fluid, an electrophoretic dispersion prepared by mixing milled particles of electrically conductive carbon black (REGAL 330 by Cabot) with a nominal particle size 80-100 nm in ISOPAR L (Mobil Chemical) at approximately 2% by weight.

The microcell structure was completely submersed into the imaging fluid, and the adhesive tape was slowly peeled off, thereby opening the holes in the cover sheet to the surrounding imaging fluid at atmospheric pressure. The previously evacuated cells where immediately filled with the imaging fluid that was pushed into the microcells through the fill holes in the cover sheet under the influence of the imaging fluid at atmospheric pressure. The filled microcell structure was removed from the dish and the excess imaging fluid film remaining on the cover sheet containing the holes was wiped away to clean the surface. The 3M transparent SCOTCH 3750 adhesive tape was re-applied to the coversheet containing the holes to encapsulate the imaging fluid in the microcells.

The structure was then handled and inspected. The result was substantially free of entrapped air bubbles.

### PARTS LIST

10 Partitioned sheet

12 Support

14 Array of microcells

15 Adhesive layer

16 Microcell reservoirs

18 Side Walls

20 Cover sheet

21 Electrodes

26 Hole penetration envelope

28 Vacuum chamber

30 Ventable microcell sheet assembly

40 Hole-patterned sheet

50 Filling Holes

60 Temporary adhesive layer

65 Temporary substrate

70 Temporary sealing sheet

71 Tacky sealing layer or sheet

80 Temporarily sealed evacuated microcell sheet assembly

81 Process Roll

82 First Supply Roll

84 Wind-up roll

85 Unsealed filled microcell sheet assembly

86 Peeling roller

88 Cleaning station

90 Permanently sealed microcell assembly

92 Imaging fluid tank

94 Imaging fluid

102 Permanent sealing sheet

104 Second supply roll

h Microcell height

w_{c} Microcell width

x Microcell lower side wall width

z Microcell upper side wall width

wₕ Filling hole diameter

y Repeating microcell Pitch

1. A method for producing an electro-optical modulating display, the method comprising:
(a) providing a partitioned sheet comprising an array of microcell reservoirs, each microcell reservoir being no longer than 1000 μm along any dimension thereof, each microcell reservoir formed by side walls extending vertically from a lower substrate and containing an electro-optical imaging fluid;
(b) providing a cover sheet, wherein at least one of the partitioned sheet and cover sheet comprises patterned electrodes, which may be transparent, and wherein at least one of the cover sheet and partitioned sheet has a plurality of filling holes and optionally at least one of the partitioned sheet and the cover sheet comprises a patterned or unpatterned layer of bonding material;
(c) bonding the cover sheet and partitioned sheet together to form a ventable microcell sheet assembly such that the cover sheet is adherently connected to at least the tops of the side walls of the microcell array, thereby covering each microcell reservoir in the array to form an array of microcells each forming an internal enclosure except for one or more filling holes associated with each microcell in the array, thereby allowing the microcells be filled with an electro-optical imaging fluid;
(d) subjecting the array of microcells in the ventable microcell sheet to vacuum in order to create a vacuum in each microcell in the array of microcells, thereby evacuating the microcells in the array;
(e) temporarily sealing each of the microcells in the array by forming a temporary seal over all of the one or more filling holes in each microcell in the array while maintaining vacuum inside the microcells;
(f) removing the temporary seal and filling each of the microcells in the array by drawing an electro-optical imaging fluid into the internal enclosures of the microcells; and
(g) permanently sealing the filling holes to completely enclose the electro-optical imaging fluid in the microcells of the array.

2. The method of claim 1 wherein the filling holes are in the cover sheet.

3. The method of claim 1 wherein the filling holes are in the partitioned sheet.

4. The method of claim 1 wherein the filling holes are formed by laser.

5. The method of claim 4 wherein the filling holes are in the partitioned sheet and wherein the shape and thickness of the side walls are pre-designed, such that a laser of pre-selected and controlled power is able to penetrate bottom walls of the microcells but is unable to break the side walls between adjacent microcells irrespective of where the laser is applied to partitioned sheet.

6. The method of claim 1 wherein the cover sheet comprise a substrate having a patterned or unpatterned layer of adhesive, wherein the adhesive is at least located on the substrate where the cover sheet contacts the tops of the side walls in forming the ventable covered microcell sheet.

7. The method of claim 6 wherein the adhesive layer covers the entire cover sheet in the area of the cover sheet over the array of microcells.

8. The method of claim 1 wherein the tops of the side walls of the microcell reservoirs in the partitioned sheet are covered by an adhesive layer, optionally with adhesive covering a portion or all of the sides of the walls.

9. The method of claim 8 wherein the adhesive covers the entire top surface of the array of microcell reservoirs in the portioned sheet.

10. The method of claim 1 wherein the partitioned sheet and/or the cover sheet is subjected to a solvent that causes the sheets to bond together by solvent action on at least one of the sheets, without the use of an adhesive, after which the solvent is evaporated away.

11. The method of claim 1 wherein the cover sheet is laminated to the partitioned sheet by adherently contacting the surface of the cover sheet to the tops of the side walls of the microcell reservoirs and compressing the cover sheet against the partitioned sheet between a nip optionally under elevated temperature.

12. The method of claim 11 wherein an adhesive layer on the cover sheet and/or on the tops of the side walls is a heat-activated adhesive that melts at an elevated temperature during the lamination.

13. The method of claim 1 wherein the array of microcells are temporarily sealed by covering the filling holes in the cover sheet or the partitioned sheet with a temporary sealing sheet by adherently contacting the cover sheet or the partitioned sheet comprising the filling holes with a temporary sealing sheet.

14. The method of claim 13 wherein the temporary sealing sheet comprises an adhesive layer on a substrate.

15. The method of claim 13 wherein the temporary sealing sheet is a surface-attractive plastic material.

16. The method of claim 13 wherein the temporary sealing sheet is integrally part of the partitioned sheet and forms the lower surface of the partitioned sheet on the side opposite the cover sheet, wherein the temporary sealing sheet seals the filling holes on the cover sheet when the evacuated ventable covered microcell sheet is rolled up.

17. The method of claim 13 wherein the temporary sealing sheet is a film sheet separate from the evacuated ventable covered microcell sheet and seals the filling holes when it is simultaneously rolled up adjacent to the evacuated ventable covered microcell sheet.

18. The method of claim 13 wherein the temporary sealing sheet is laminated to the evacuated ventable covered microcell sheet in a nip under pressure optionally at an elevated temperature.

19. The method of claim 13 wherein the sealing step (e) is conducted in a vacuum chamber or vacuum environment.

20. The method of claim 1 wherein the temporarily sealed evacuated microcell sheet assembly is filled via the filling holes with the electro-optical imaging fluid by removing the temporary seal while substantially simultaneously allowing the electro-optical imaging fluid under relative pressure to enter the microcells through the filling holes, thereby forming a unsealed filled microcell sheet assembly.

21. The method of claim 20 wherein the temporarily sealed evacuated microcell sheet assembly is in the form of a roll that is unwound from a first roll and a permanent sealing sheet is removed by a second roller wherein the first roll and second roll are both immersed in the electro-optical imaging fluid.

22. The method of claim 21 wherein the temporarily sealed evacuated microcell sheet assembly is in the form of a roll that is unwound from a first roll immersed in the electro-optical imaging fluid, such that merely the unrolling of the sheet unseals the microcells in the sheet.

23. The method of claim 20 wherein after the unsealed and filled microcell sheet assembly is transported out of the electro-optical imaging fluid, it is permanently sealed by using a permanent sealing sheet placed over the filling holes to sealingly enclose the electro-optical imaging fluid in the array of microcells.

24. The method of claim 23 wherein the unsealed and filled microcell sheet assembly is laminated with a permanent sealing sheet in a nip under pressure optionally at an elevated temperature.

25. The method of claim 23 wherein the unsealed and filled microcell sheet assembly emerges from a pool of electro-optical imaging fluid held in a tank and excess electro-optical imaging fluid is removed or cleaned at least from the surface of the sheet assembly having filing holes prior to application of a permanent sealing sheet.

26. The method of claim 25 wherein excess fluid is removed by a scraping or wiping means, air knife, and/or absorbent material.

27. The method of claim 1 wherein the electro-optical imaging fluid comprises charged particles dispersed in a carrier fluid.

28. The method of claim 1 wherein each microcell in the array is 200 to 600 μm along any dimension thereof and is symmetrical or non-symmetrical in plan view.

29. The method of claim 1 wherein the microcell array, in plan view, has a circular, rectangular, square, or hexagonal shape.

30. The method of claim 1 wherein the microcell array, in plan view, has a rectangular or square shape with side dimensional ratio of 1:1 to 1:5.

31. The method of claim 27 wherein the particles are solid materials.

32. The method of claim 27 wherein the carrier fluid is transparent or colored organic dielectric fluid.

33. The method of claim 27 wherein the carrier fluid is an organic dielectric fluid having a long chain hydrocarbon or paraffin, optionally halogenated.

34. An electro-optical modulating display comprising an array of microcells each sealingly filled with an electro-optical imaging fluid, the display comprising:
(a) a first sheet comprising an array of microcell reservoirs, each microcell reservoir being no longer than 1000 μm along any dimension thereof, each microcell reservoir formed by side walls extending vertically from a lower substrate and containing an electro-optical imaging fluid;
(b) a second sheet laminated to the first sheet, the second sheet covering each of the filled microcell reservoirs in the array, wherein the second sheet is bonded at least to the tops of the side walls of each microcell reservoir in the array, wherein either the first sheet and/or the second sheet is a hole-patterned sheet comprising a plurality of filling holes such that one or more of the plurality of filling holes is associated with each microcell in the array, and wherein the filling holes in each of the microcells in the array have been commonly sealed by a unitary layer of material;
(c) an electrical driver for providing control of electrical switching of the optical state of the electro-optical imaging fluid in each microcell in the array.

35. The display of claim 34 wherein the hole-patterned sheet is formed with a uniform pattern of filling holes, each a substantially uniform size and distance from each other and each smaller in diameter than the wall thickness of the side walls.

36. The display of claim 35 wherein the hole-patterned sheet comprises more than one filling hole associated with each microcell in the array.

37. The display of claim 35 wherein the hole-patterned sheet comprises filling holes that are separated by a distance less than the repeating pitch of the microcells.

38. The display of claim 35 wherein the hole-patterned sheet comprises filling holes that are separated by a distance at least three times the hole diameter.

39. The display of claim 34 wherein the hole-patterned sheet has a random pattern of filling holes wherein each filling does not have a substantially uniform size and distance from each other, however, wherein each filling hole is smaller in diameter than the base of the side wall if the hole-patterned sheet is the first sheet, and wherein each filling hole is no greater than the top width of the side walls if the hole-patterned sheet is the second sheet.

40. The display of claim 34 wherein the filling holes are perforations formed during the manufacture of the cover sheet material itself without the manufacture of a corresponding unperforated sheet.

41. The display of claim 34 wherein the filling holes are perforations formed after the manufacture of a corresponding unperforated sheet.

42. The display of claim 34 further comprising a patterned element having optical or electrical functionality associated with individual microcells of the array that provides a functionality selected from a the group comprising a mask designed to hide particles in the electro-optical fluid, bus bars, collector electrodes, gate electrodes, flag electrodes, electrode pad areas, and combinations thereof.

43. The display of claim 42 wherein the first sheet or the second sheet comprises patterned electrodes and contacts for the patterned electrodes.

44. The electro-optical modulated display of claim 34 wherein the electro-optical imaging fluid comprises charged particles dispersed in a carrier fluid that is a transparent or colored organic dielectric fluid comprising a long chain hydrocarbon or paraffin, optionally halogenated.

45. The display of claim 34 wherein the electro-optical imaging fluid is a dry non-liquid fluid comprising charged particles.

46. The display of claim 34 wherein the first and second sheets are both made from flexible polymeric materials not comprising glass.
